(19) United States
(12) Patent Application Publication
(10) Pub. No.: US 2013/0224532 A1
(43) Pub. Date: Aug. 29, 2013

(54) BATTERY ASSEMBLY

(71) Applicants: Henrik Bengtsson, Goteborg (SE); Magnus Jonsson, Vastra Frolunda (SE); Erik Pettersson, Stenungsund (SE); Magnus Torell, Stenungsund (SE); David Helgeson, Kungalv (SE); Dag Lundstrom, Onsala (SE); Niklas Angebrand, Goteborg (SE)

(72) Inventors: Henrik Bengtsson, Goteborg (SE); Magnus Jonsson, Vastra Frolunda (SE); Erik Pettersson, Stenungsund (SE); Magnus Torell, Stenungsund (SE); David Helgeson, Kungalv (SE); Dag Lundstrom, Onsala (SE); Niklas Angebrand, Goteborg (SE)

(73) Assignee: ALELION BATTERIES AB, Mölndal (SE)

(21) Appl. No.: 13/883,200

(22) PCT Filed: Nov. 5, 2010
(86) PCT No.: PCT/SE2010/051213

§ 371 Date: May 2, 2013

(51) Int. Cl. H01M 10/48; H01M 10/04

(52) U.S. Cl. CPC H01M 10/486; H01M 10/04
USPC 429/7; 29/623.1

(57) ABSTRACT

Battery assembly comprising a plurality of battery blocks, where each battery block comprises a first metal plate fixedly connected to the positive terminals of a plurality of rechargeable battery cell members and a second metal plate fixedly connected to the negative terminals of the cell members, further comprising a printed circuit board provided with an electronic circuit configured to monitor, control and/or balance said battery blocks, where the metal plates of subsequent battery blocks are fixedly connected to each other such that the battery blocks are electrically configured in series, and where the PCB is mechanically fixed to mounting flanges of the metal plates with mounting means that also provides an electric connection between the metal plates and the PCB. The advantage of the invention is that a self-supporting battery assembly that can be produced in a cost-effective way is provided.

### TECHNICAL FIELD

This invention relates to a battery assembly comprising a plurality of battery blocks. In particular, the invention relates to a rechargeable battery assembly for applications requiring a relatively high power, such as driving of vehicles. The invention also relates to a battery system comprising a plurality of battery assemblies.

### BACKGROUND OF THE INVENTION

Rechargeable batteries of the lithium-ion (Li-ion) or nickel-cadmium (Ni—Cd) type, or similar, have become increasingly interesting as an energy source for driving vehicles (cars, golf-carts, motor-bikes etc.) and other devices, such as boat engines and cleaning machines, as well as for powering e.g. cellular network base stations (together with solar or wind power equipment) in remote areas.

In such applications several battery cells are connected in series and/or parallel in a battery pack or assembly such as to be capable of delivering the required power/current/voltage. Normally, a battery pack of this type includes a battery management system (BMS), i.e. electronic equipment for monitoring, controlling and/or balancing the cells and the battery pack.

Smaller battery packs for computers, camcorder and the like have been on the market for some years and are rather well developed. Larger battery packs, i.e. battery packs for driving e.g. vehicles, make use of larger and heavier battery packs and operate with higher currents (typically with a power output of at least around 100 W and a current exceeding 10 A). This leads to somewhat different challenges, for instance how the heat developed during use should be handled and how the pack should be physically designed for holding the cells and the associated electronics together.

A conventional solution for larger battery packs of e.g. LI-ion battery cells make use of a strip of nickel (Ni) that is spot-welded to the poles or terminals of the cells and soldered, often via cables, to a printed circuit board (PCB) containing an electronic circuit for battery management. The Ni-strip is further often used to hold the pack together. The PCB is normally fastened in some way to the outside of the pack.

Although this traditional design is well established and generally applied it has some drawbacks in that the method of production is rather complicated and time-consuming, in that it is sometimes difficult to hold the cells in place properly using only the Ni-strip, and in that the electrical losses are relatively high. There is thus room for improvements.

### SUMMARY OF THE INVENTION

An object of this invention therefore to provide a battery assembly that is self-supporting. A further object of the invention is to provide a battery assembly that is cost-effective to produce. A further object of the invention is to provide a battery assembly that can measure the temperature in the battery assembly and use this measure to estimate the temperature in the battery assembly and in the battery blocks of the battery assembly.

This object is achieved by the battery assembly defined by the technical features contained in independent claim 1. The dependent claims contain advantageous embodiments, further developments and variants of the invention.

The invention concerns a battery assembly comprising a plurality of battery blocks, where each block comprises a plurality of rechargeable battery cell members that are arranged side by side in at least one row and that are electrically configured in parallel, where each block comprises a first metal plate fixedly connected to the positive electrode terminals of the cell members and a second metal plate fixedly connected to the negative electrode terminals of the cell members, and a printed circuit board (PCB) provided with an electronic circuit configured to monitor, control and/or balance said battery blocks, and mounting means arranged to connect the metal plates to the PCB.

The invention is characterized in that the first metal plate of a first battery block is fixedly connected to the second metal plate of a second battery block, such that the battery blocks are electrically configured in series, and that the PCB is mechanically fixed to the metal plates with the mounting means that also provides an electric connection between the metal plates and the PCB.

Thus, in the inventive design, a self supporting battery assembly with an improved current conducting capacity is provided for. The battery cells of a battery block are fixedly connected to the two metal plates of the battery block. The metal plates are part of the supporting structure that holds the battery cells in position and functions also as a rather massive electrical conductor. These conductors are in turn capable of, on the one hand, leading an electrical current with small electrical losses to and from the positive and negative terminals of the cells in the battery block and, on the other hand, leading an electrical current directly to and from the electronic circuit provided on the PCB without having to conduct (or providing means for conducting) the current through additional components, such as cables and cable contacts, for connecting the plate and the PCB.

An advantageous effect achieved with this design is a reduction of the electrical losses due to the large conductor (compared to e.g. the conventional Ni-strips) and the direct electrical connection between the metal plates and the PCB. Another advantageous effect of this design is that it makes the manufacture more efficient since cables are not required. A further advantageous effect is the dual function (supporting-conducting) of the metal plates which, for instance, leads to a reduction in the number of components and thereby makes the manufacture more cost-effective.

A further advantage is that the metal plates are also efficient heat conductors. The heat generated in the battery blocks in the battery assembly can thus be measured on the PCB without the need of external temperature sensors. The temperature is instead measured through the mechanical connection between the metal plates and the PCB. The temperature measured at the PCB is used to estimate the temperature in the battery assembly. By measuring the temperature at each mounting flange, i.e. at each side of each battery block, the temperature of each battery block can be estimated. By comparing these estimated temperature values with the voltage over each battery block and also with the charge or discharge current value for the battery assembly, the condition of the battery assembly and also for individual battery blocks can be estimated and monitored.

The invention also concerns a battery system comprising a plurality of battery assemblies of the above type.

The invention also concerns a method for producing a battery assembly of the above type.

### BRIEF DESCRIPTION OF DRAWINGS

In the description of the invention given below reference is made to the following figure, in which:

FIG. 1 shows, in a perspective view, a battery assembly according to the invention.

### DESCRIPTION OF EXAMPLE EMBODIMENTS OF THE INVENTION

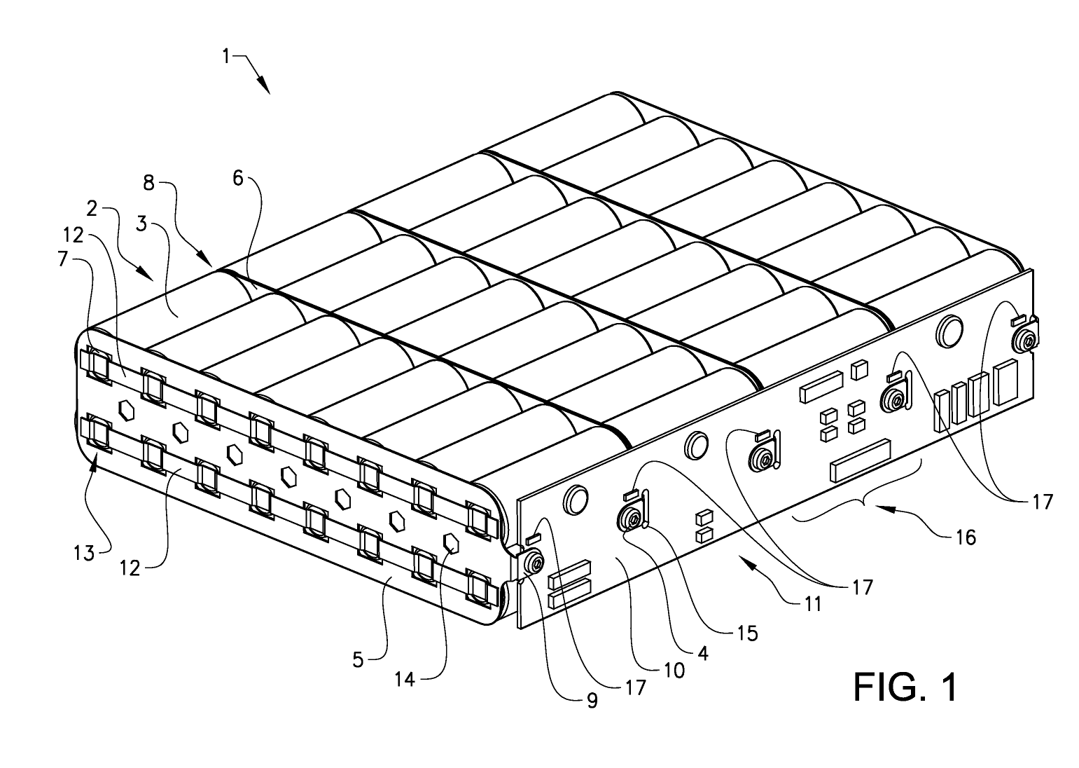

FIG. 1 shows a first preferred embodiment of a battery assembly 1 according to the invention.

The battery assembly 1 comprises, in this example, four similar battery blocks 2 of rechargeable battery cells 3 and a printed circuit board (PCB) 10 provided with an electronic circuit 11 (only schematically shown in the figures) configured to monitor and control the battery assembly 1 and to balance each of the cell blocks 2. The PCB is mounted to the battery blocks 2 by mounting means 4 arranged to electrically connect the cell blocks 2 to the PCB 10 and also to mechanically hold the PCB in a fixed position.

Each battery block 4 comprises a plurality of rechargeable battery cells 3 arranged side by side in one or more rows. The positive electrode terminals 7 of the cell members 2 are fixedly connected to a first metal plate 5 and the negative electrode terminals 8 of the cell members 2 are fixedly connected to a second metal plate 6. The shape of the first metal plate 5 and the second metal plate 6 may be identical, which is of advantage for an effective production, or may be adapted for the respective electrode terminals of the battery cells.

The number of battery cells in each block 2 is adapted to the requirements of the system. In the shown example, the battery block comprises 16 battery cells arranged in two rows. Since the battery cells in each block are electrically configured in parallel, the capacity of the battery assembly is decided by the number of battery cells in each block. The battery cells are elongated cylindrical cells 3 with a positive electrode terminal 7, i.e. anode terminal, arranged at one end of the battery cell and a negative electrode terminal 8, i.e. cathode terminal, arranged at the opposite end. Each cell 3 has a circular cross-section. The curved cylindrical surface of each cell 3 is provided with an electrically insulating covering.

The first and second metal plates 5, 6 extend along opposite sides of the row of cells 3 in each battery block 2, wherein the first plate 5 has one side facing the positive electrode terminals 7 of the cells 3 in a block of cells and wherein the second plate 6 has one side facing the negative electrode terminals 8 of the cells 3 in the same block of battery cells. The size of a metal plate 5, 6 is such that it substantially covers the end regions of all the battery cells. The first metal plate 5 further comprises a mounting flange 9 extending from one short side of the metal plate. In this example, the first and second metal plates 5, 6 are identical apart from the mounting flange and are made of brass with a thickness of 0.7 mm.

The first metal plate 5 is fixed to the battery cells 3 of the battery block 2 via a first mechanical fixation. In particular, the first metal plate 5 is electrically connected and mechanically fixed to the positive electrode terminal 7 of each of the cells 3 in the block 2 by means of, in this example, a single Ni-strip 12 that extends along the plate 5 and that is spot-welded onto each of the positive electrode terminals 7 as well as to the first metal plate 5 at both sides of the positive electrode terminal 7. Each metal plate 5, 6 is provided with openings 13 in positions corresponding to that of each terminal 7 in an assembled battery block. Thus, the openings 13 provide access to the terminals 7 with the metal plate 5 surrounding the terminal 7. This allows a single, straight Ni-strip 12 to be spot-welded onto the metal plate on each side of each of the openings 13. This provides for an efficient manufacturing method, a high-strength mechanical fixation and a good electrical conduction between the positive electrode terminal 7 and the metal plate 5 (via the spot-welds and the, compared to prior art, short Ni-strip).

The second metal plate 6 is fixed to the battery cells 3 of the battery block 2 via a first mechanical fixation. In particular, the second metal plate 6 is electrically connected and mechanically fixed to the negative electrode terminal 8 of each of the cells 3 in the block 2 by means of a single Ni-strip 12 that extends along the plate 6 and that is spot-welded onto each of the negative electrode terminals 8 as well as to the second metal plate 6 at both sides of the negative electrode terminal 8, in the same way as described for the first metal plate.

A main function of arranging the metal plates 5, 6 as described above is that the electrical losses are reduced. Since each plate 5, 6 provides a large electric conductor from the connection to the Ni-strip 12 to the PCB 10 with a minimum of electrical losses, and since the length of the current conducting Ni-strip 12 is kept to a minimum (i.e. the length between the spot-weld that connects the Ni-strip 12 to the electrical terminals 7, 8 and the spot-weld that connects the Ni-strip 8 to the metal plate 5, 6), the total electrical losses are reduced compared to conventional battery assemblies where the current must be conducted a much longer distance through the Ni-strip and perhaps also must pass cable connections. Reduction of electrical losses increases in turn the efficiency of the battery assembly 1 including a reduction of the amount of heat generated during operation. Reduction of heat generation has a further advantage in that the lifetime of electrical components as well as battery cells is increased. Ni typically has poor conductive properties so the length of any such strip should be kept to a minimum to reduce electrical losses.

Another main function of t h e metal plate arrangement is the mechanical/electrical fixation of the PCB 10 to the metal plates 5, 6 which makes it possible to mount the PCB to the battery blocks without the need of soldering. This simplifies and speeds up the manufacturing process of the battery assembly 1. Further, the replacement of a PCB or a pack of battery blocks is simplified since no soldering is needed. One drawback with soldering such metal plates standing in contact with the battery cells is the great amount of heat required to solder the metal plate. There is a great risk of damaging components of the electronic circuit during such a soldering operation.

A further main function of the metal plate arrangement is that the rigid metal plates 5, 6 provides for a battery assembly 1 that is self supporting and thus is easy and safe to handle.

The first metal plate 5 further comprises one or more openings 14 that can be used to connect the battery assembly with a cable to a further battery assembly or to a battery management system in e.g. an electric vehicle. A threaded rivet or a press-fit nut is then inserted in the opening, such that the connection can be fastened with a machine threaded screw or bolt in a removable manner. If a rivet is used, the connection may have a small recess that will correspond to the protruding part of the rivet.

The battery assembly 1 comprises a plurality of battery blocks 2 as described above. In the battery assembly, two or more battery blocks are electrically connected in series. The connection of the battery blocks to each other are preferably made by spot welding, in that the second metal plate of a first battery block, having a negative polarity, is spot welded to the first metal plate of a second battery block, having a positive polarity. Since the battery cells are circular, there is room between the battery cells at the long side of the battery block for the tip electrodes of the spot welding machine. The remaining battery blocks of the battery assembly are spot welded to each other in the same way. In this way, the battery assembly 1 will comprise a number of battery blocks connected in series. In order to allow the connection of the PCB to all the poles of the battery assembly, both the first and the second metal plate of the last battery block must comprise a mounting flange. In this way, a mechanically stable and self-supporting battery assembly is obtained.

In a first example, the PCB is mounted to the battery assembly in the following way. The PCB comprises slits 15 that correspond to the mounting flanges 9. The PCB is mounted to the battery blocks with the mounting flanges protruding through the slits 15. The mounting flanges are bent by 90 degrees after the insertion through the slits such that they bear on the front side of the PCB surface and are fixed to the PCB by screws 4. The front side of the PCB is the side of the PCB that points away from the battery assembly. The rear side of the PCB is thus the side of the PCB closest to the battery assembly. The PCB is for this purpose provided with press-fit nuts on the rear side. The mounting flanges are preferably provided with a weakening which defines the bending position of the mounting flanges. In this way, the mounting position of the PCB is defined. The PCB is positioned a short distance above the battery blocks and does not bear on the battery blocks.

In a second example, the PCB is mounted to the battery assembly in the following way. In this example, the slits 15 extend to the long side of the PCB. In this way, the mounting flanges 9 can be bent before the PCB is mounted and even before the battery cells are mounted to the metal plates. The PCB is in this example slid sideways on the pre-bent mounting flanges and when the mounting flanges has reached their mounting positions, the PCB is fixed to the PCB by screws 4. The PCB is for this purpose also provided with press-fit nuts on the rear side. If this mounting method is used, it is possible to position the mounting flanges in an asymmetric way on the metal plates, such that the length of the slits is minimized which will improve the stability of the PCB.

It is also possible to attach the PCB to the mounting flanges 9 with the mounting flanges bearing on the rear side of the PCB. In this case, the mounting flanges are provides with a thread of some kind, e.g. a press-fit nut. If the PCB or the battery assembly should not be taken apart, it would also be possible to use self-threading screws or rivets to fixate the PCB to the mounting flanges

The PCB is provided with an electrical connection where the mounting flanges bear on the PCB, such that an electrical connection between the metal plates and the electronic circuit of the PCB is obtained. This electrical connection comprises a screw 4, an optional electrically conducting spacer and a press-fit nut pressed into the PCB 10 that fix the mounting flange 9 to an electrically conducting area of the PCB, such as a tinned copper pad, which the electrically conducting area is electrically connected to the electrical circuit 11 of the PCB 10. The electrically conducting area can be designed in different ways. In a preferred variant, the electrically conducting area includes a ring of conducting material around the screw hole on both sides of the PCB 10 as well as vertically arranged conducting material that connects the two rings.

The size of the PCB is advantageously such that it does not extend outside of the sides of the battery blocks. The PCB is for this reason provided with cut-outs for the two outer mounting flanges instead of slits. It is also possible to apply a heat generating foil on the battery cells, either on the sides of the battery blocks or on the two outer metal plates of the battery assembly.

The battery assembly is preferably mounted in a housing of some kind. The housing may comprise cooling/heating channels and fastening/holding means adapted to hold the battery assembly in a fixed position in e.g. an electrical vehicle. The positive and negative terminal of the battery assembly is connected to other battery assemblies and/or a current management system of the vehicle by high-current cables. The control system of the vehicle is connected to the PCB where the monitor, control and/or balancing system of the battery assembly is situated. The electronic circuit of the PCB may be powered from an external source or may be powered directly from the battery blocks of the battery assembly.

In the embodiment described above the brass used in the metal plates is ISO5150-4/CW508L which contains around 63% Cu and 37% Zn. Higher Cu-content leads to increased conductivity both with regard to electricity and temperature. High electrical conductivity is desired but if the Cu-content is too high, spot welding becomes more difficult because of the increased capacity of conducting heat. The brass used provides a useful trade-off between sufficiently high electrical conductivity and sufficiently low thermal conductivity with regards to spot welding. For the embodiment described above, a suitable Cu-content of the first and second metal plates 5, 6 is around 60-66%.

In order to provide a sufficient strength and rigidity for its self supporting function, and in order to provide a sufficiently high capacity of conducting electricity, the metal plates 5, 6 should, in the example described, have a thickness of at least around 0.5 mm. Thicker plates, up to several mm, may be of interest for larger currents. The minimum thickness depends on the material and design of the plate as well as on the type, number and weight of the cells to support.

The exact design of the metal plates 5, 6 and Ni-strip 12 as well as e.g. the positions of the spot-welds can be varied compared to what is described above. For instance, the openings 13 may have a different shape and/or position in relation to the metal plates 5, 6. Further, instead of a single, longer Ni-strip 12 it is possible to make use of several short Ni-strips, e.g. one or two arranged at each terminal 7, 8. However, the above described arrangement, i.e. with openings 13 and with one single Ni-strip 12 extending along the row of cells 3, provides for an efficient production process.

Besides thermal conductivity, plate thickness is of interest with regard to welding since the thicker the plate, the more heat will be conducted to other components during the welding process. Very thin plates (which may not be denoted plate but rather e.g. foil) are, however, not of interest because the capacity of conducting electricity will be too low and the supporting capability will also be reduced.

By using another mounting method to connect the battery cells to the metal plates, also thicker metal plates can be used. It is possible to use an electrically conductive adhesive or glue, such as an electrically conductive epoxy resin, to attach the battery cells to the metal plates and also to attach the metal plates to each other. When an adhesive or glue is used, a larger contact surface between the battery cells and the metal plates as well as between the metal plates can be used compared to spot welding, which can compensate for a possible lower conductivity of the adhesive.

In a development of the invention, the first and/or second metal plate 5, 6 is spot-welded directly to the electrode terminals 7, 8. In this variant, neither Ni-strips 12 nor any openings 13 are required. In this way the electrical losses can be further reduced because the current no longer has to pass through any Ni-strip and because there is only one, instead of two spot-welded contacts between the cell terminal 7, 8 and the metal plates 5, 6.

In order for such a metal plate to be sufficiently thick, in order to provide a sufficient electrical conductivity and mechanical stability, and at the same time allow spot welding, the plate is preferably provided with zones having a smaller thickness. These zones are arranged in positions corresponding to that of each battery terminal, i.e. at the positions of the openings 13.

To allow for an efficient production of such metal plates with varying thickness, such as extrusion, the plate preferably has a zone with decreased thickness that is not only present in positions corresponding to those of the terminals but that extends along the entire length of the plate. A cross section of such a plate does not change along the length of the plate and it can thus be extruded. The position, in relation to the sides of the plate, and the width of this thinner zone can be adapted to the particular application. Irrespective of the exact design of this thinner zone, such a plate is arranged to the block of cells in such a way that the thinner zone is contacted directly with each of the positive or negative electrode terminals 7, 8 of the cells 3 in a block 2. An alternative material of the metal plates is aluminium. Other Al- or Cu-based alloys are also conceivable.

The spot-welding of the Ni-strip 12 or metal plates 5, 6 to the electrode terminals 7, 8 mentioned above can in all variants and embodiments described in principle be replaced by e.g. a clamping arrangement or other joining technique. However, spot-welding is a generally accepted method that normally provides for a reliable and firm electrical and mechanical connection. A weaker electrical connection of the Ni-strip/metal plate to the terminals 7, 8 can be complemented with a further mechanical fixation that fixes the metal plates 5, 6 further to the block 2 of battery cells.

Also the connection between the metal plate 6, 7 and the PCB 10 can be arranged in other ways without employing soldering. An example is various forms of press-fitting or riveting. It is however of advantage that the connection is possible to open for reassembly.

The individual cells in the embodiments described above are Li-ion cells (LiFePO4-cells) of size-type 26650 (diameter 26 mm, length 65 mm) and with a voltage of 3.2 V and a capacity of 10 Wh. Other battery cells that are suitable for the battery assembly according to the invention are primarily other types of Li-ion cells, such as LCO and NMC, as well as e.g. NIMH-cells. The shape of the cells does not necessarily have to be circular cylinders.

The battery assembly 1 exemplified here, i.e. with four cell blocks 2 arranged in series and with 16 cells 3 in each block 2, has a voltage of 12.8 V and a capacity of approximately 55 Ah, (around 700 Wh). Higher capacities can be achieved by increasing the number of cells in the cell blocks. Several battery assemblies of the inventive type can be combined/connected such as to achieve a much higher capacity, both by connecting them in series and in parallel. The PCB 10 is preferably of an epoxy based type with a thickness of around 1.6 mm or more.

The electronic circuit 11 for battery management is in the described example arranged to monitor, control and/or balance said battery blocks in the battery assembly. It is important that each battery block can be monitored, controlled and/or balanced individually in order to optimise the capacity and life of the battery assembly. The most important measures are the battery block voltage, the charge and discharge current through the battery block and the battery block temperature. The electronic circuit thus comprises one circuit block 16 for each battery block. Each circuit block 16 is configured to measure each battery block between the positive and negative terminals through the mounting flanges 9 of the metal plates. The circuit block will measure the voltage for each battery block. This voltage can be used to monitor and to balance the battery blocks individually in each battery assembly.

The electronic circuit 11 further comprises temperature sensors 17, one for each mounting flange, which measures the temperature at each mounting flange 9. The PCB connection for the mounting flange is preferably, as described above, relatively large which means that the temperature of the metal plate and thus of the mounting flange will be transferred to the PCB connection. The temperature sensor is preferably positioned close to the mounting flange. In this way, the temperature of the metal plate can be measured with a high accuracy on the PCB. The PCB may be provided with an additional heat conducting means in order to increase the amount of heat transferred to the temperature sensor. It is e.g. possible to mount an extra metal foil over the temperature sensor, e.g. integrated in the mounting flange. The temperature measured will be an average temperature of the metal plate connected to the mounting flange. Depending on the mounting position of the temperature sensor, the heat transfer function for the metal plate and the battery blocks can be calculated. By comparing the temperature measured at each mounting flange, the temperature distribution in the battery assembly can be estimated.

It is also possible to estimate the temperature of each battery block. Since the current through the system is known, the current through each battery assembly is known. By using this current information, the loss in a battery block can be estimated by using the temperature values measured at the mounting flanges of that battery block. This estimation can be further improved by using one or more temperature measurements from other mounting flanges. The internal resistance of each block can also be estimated by using the temperature measured together with the current information. The inner resistance can be used to estimate the aging of a battery block.

The temperature sensor may be either a resistance temperature detector where the resistance varies with the temperature or a thermo coupler where a voltage is produced depending on the temperature. The resistance temperature detector may have either a positive temperature coefficient (PTC) or a negative temperature coefficient (NTC) and may be configured either in a two, three or four-wire setup. The temperature reading is preferably made by a microcontroller having an analog-to-digital converter with a sufficiently high resolution.

The electronic circuit 11 can also be provided with another temperature sensor, positioned away from the mounting flanges. This temperature sensor is used to measure the ambient temperature which can be used to improve the temperature estimation for the battery assembly and for the temperature estimations for the individual battery blocks. It is also possible for the electronic circuit 11 to receive a central temperature signal from an external control unit. This temperature signal may be the ambient temperature for the electric system and/or the ambient temperature for e.g. the vehicle in which the battery assembly is mounted.

The temperature is measured at each mounting flange 9, i.e. at each battery block terminal. The voltage difference between battery blocks can be used to balance the battery blocks, both in the battery assembly and between battery blocks in other battery assemblies in the electrical system. Each circuit block thus comprises a balancing circuit that will detect a voltage difference for a battery block and will, especially during charging, balance the charge current through that battery block such that all battery blocks will charge equal. This will prevent a battery block from overheating.

The temperature measure can also be used to control heating and cooling of the battery assembly. When the control system of the electronic circuit 11 detects that the battery assembly is too cold for an optimal performance, the electronic circuit 11 comprises a switch unit that will switch on one or more heating foils (not shown) mounted on the battery assembly. The heating foils may be mounted either on the sides of the battery assembly or may be mounted on the two outer metal plates. The electronic circuit 11 will measure the amount of power supplied to the heating foils and can thus detect the amount of heat generated by the heating foils. The applied heat measure can be compared to the temperature change at the mounting flanges, and this can in turn be used to determine the total heat loss for the battery assembly. The temperature measurements can also be used to control a cooling fan when the temperature of the battery assembly or of a battery block is too high.

Further, the temperature behaviour in the battery assembly can be predicted by knowing the power supplied to the heating foils. When the actual temperature increase in the battery assembly does not correspond to the temperature increase predicted from the power applied to the heating foils, it can be assumed that there is something wrong with the heating foils. It is for example possible that a heating foil is no longer in contact with the battery assembly, which leads to a decreased heat transfer. It is also possible that the heat foil is partly broken.

Further, the measure of voltage and measure and estimations of temperature can be used to monitor and detect different faults on the battery assembly or on a specific battery block. In this way, the electronic circuit 11 can detect excessive heat in a battery block, excessive voltage in a battery block, excessive loss in a battery block, a broken heating foil or a broken temperature sensor. Depending on the detected measure, the electronic circuit 11 can send out an alarm signal or may even shut down the system in order to prevent a breakdown. It is for example possible to detect if the connection between two battery blocks has deteriorated, e.g. that part of the spot welds have disconnected. In this case, the loss in the connection between two battery blocks will cause a temperature rise in that connection, especially at high currents, which can be detected by measuring the temperatures for the different mounting flanges together with the current through the battery assembly.

The electronic circuit 11 further comprises a serial bus communication capable of communicating with an external control unit and/or other battery assemblies, for instance regarding important battery conditions that might be required for a larger system.

The invention is not limited by the embodiments described above but can be modified in various ways within the scope of the claims. For instance, the number of rows of battery cells and the number of battery cells in each row within the same cell block can be altered. The shape of the battery cells may also be other than circular.

1. Battery assembly

2. Battery block

3. Battery cell

4. Mounting means

5. First metal plate

6. Second metal plate

7. Positive electrode

8. Negative electrode

9. Mounting flange

10. Printed circuit board (PCB)

11. Electronic circuit

12. Ni-strip

13. Opening

14. Opening

15. Slit

16. Circuit block

17. Temperature sensor

1. A battery assembly comprising:
a plurality of battery blocks, where each block comprises a plurality of rechargeable battery cell members that are arranged side by side in at least one row and that are electrically configured in parallel, where each block comprises a first metal plate fixedly connected to the positive electrode terminals of the cell members and a second metal plate fixedly connected to the negative electrode terminals of the cell members,
a printed circuit board (PCB) provided with an electronic circuit configured to monitor, control and/or balance said battery blocks,
mounting means arranged to connect the metal plates to the PCB, characterized in that wherein the first metal plate of a first battery block is fixedly connected to the second metal plate of a second battery block, such that the battery blocks are electrically configured in series, and that the PCB is mechanically fixed to the metal plates with the mounting means that also provides an electric connection between the metal plates and the PCB.

2. The battery assembly according to claim 1,
wherein a metal plate comprises a mounting flange that is adapted to extend through a slit in the PCB, and further adapted to be bent before or after insertion of the mounting flange through the slit such that the mounting flange will bear on the PCB.

3. The battery assembly according to claim 2,
wherein the mounting flange is mounted to the PCB by a screw that is threaded in a press-fit nut in the PC.

4. The battery assembly according to claim 1,
wherein the PCB further comprises a plurality of temperature sensors, where each temperature sensor is adapted to measure the temperature of a metal plate through a mounting flange.

5. The battery assembly according to claim 4,
wherein the temperature sensors are arranged in the vicinity of the mounting flanges.

6. The battery assembly according to claim 4,
wherein the electronic circuit of the PCB further comprises a circuitry that is adapted to estimate the temperature of a battery block depending on the temperature measured by at least two of the temperature sensors at the mounting flanges of the battery blocks.

7. The battery assembly according to claim 4,
wherein the temperature values measured by at least one of the temperature sensors are further used to control a heating device attached to the battery assembly.

8. The battery assembly according to claim 1,
wherein the first metal plate is fixedly connected to the positive electrode terminals and the second metal plate is fixedly connected to the negative electrode terminals and/or that the first metal plate of a first battery block is fixedly connected to the second metal plate of a second battery block by spot welding.

9. The battery assembly according to claim 1,
wherein the first metal plate is fixedly connected to the positive electrode terminals and the second metal plate is fixedly connected to the negative electrode terminals and/or that the first metal plate of a first battery block is fixedly connected to the second metal plate of a second battery block by an electrically conductive adhesive.

10. A battery system comprising: a plurality of battery assemblies, at least one of the plurality of battery assemblies including:
a plurality of battery blocks, where each block comprises a plurality of rechargeable battery cell members that are arranged side by side in at least one row and that are electrically configured in parallel, where each block comprises a first metal plate fixedly connected to the positive electrode terminal of the cell members and a second metal plate fixedly connected to the negative electrode terminals of the cell members,
a printed circuit board (PCB) provided with an electronic circuit configured to monitor, control and/or balance said battery blocks,
mounting means arranged to connect the metal plates to the PCB,
wherein the first metal plate of a first battery block is fixedly connected to the second metal plate of a second battery block, such that the battery blocks are electrically configured in series, and that the PCB is mechanically fixed to the metal plates with the mounting means that also provides an electric connection between the metal plates and the PCB.

11. A method for comprising:
producing a battery assembly the battery assembly including:
a plurality of battery blocks, where each block comprises a plurality of rechargeable battery cell members that are arranged side by side in at least one row and that are electrically configured in parallel, where each block comprises a first metal plate fixedly connected to the positive electrode terminal of the cell members and a second metal plate fixedly connected to the negative electrode terminals of the cell members,
a printed circuit board (PCB) provided with an electronic circuit configured to monitor, control and/or balance said battery blocks,
mounting means arranged to connect the metal plates to the PCB,
wherein the first metal plate of a first battery block is fixedly connected to the second metal plate of a second battery block, such that the battery blocks are electrically configured series, and that the PCB is mechanically fixed to the metal plates with the mounting means that also provides an electric connection between the metal plates and the PCB.
the method further comprising:
fixedly connecting a first metal plate to the positive terminals of a plurality of rechargeable battery cell members,
fixedly connecting a second metal plate to the negative terminals of the plurality of rechargeable battery cell members, such that a battery block is formed,
fixedly connecting the first metal plate of a first battery block to the second metal plate of a second battery block and repeating this for the required number of battery blocks,
placing a PCB on the battery blocks such that a mounting flange for each battery block bears on the surface of the PCB,
bending the mounting flanges before or after the PCB is mounted to the battery blocks, and
fixing the mounting flanges to the PCB with mounting means.

12. The method according to claim 11, where the mounting means are screws.

13. The method according to claim 11, where the metal plates are fixedly connected to the terminals of the rechargeable batteries by spot welding.

14. The method according to claim 11, where the metal plates are fixedly connected to the terminals of the rechargeable batteries by an electrically conductive adhesive.
